(19) United States
(12) Patent Application Publication
(10) Pub. No.: US 2009/0028110 A1
(43) Pub. Date: Jan. 29, 2009

(54) Seamless Establishment and Maintenance of Network Connections for Mobile Applications

(75) Inventors: Hung-Yi Chen, Jhonghe (TW); Ching-Hung Chou, Taipei (TW)

Correspondence Address: Venture Pacific Law, PC, 5201 Great America Parkway, Suite 270, Santa Clara, CA, 95054, US

(73) Assignee: Anthropedia International Co., Ltd., Taipei (TW)

(21) Appl. No.: 12/181,304

(22) Filed: Jul. 28, 2008

Related U.S. Application Data
(60) Provisional application No. 60/952,536, filed on Jul. 27, 2007.

(51) Int. Cl. H04W 36/18

(52) U.S. Cl. 370/331

(57) ABSTRACT

This invention provides a seamless mobile connection system that can maintain connectivity as a cell phone's Internet protocol changes due to changes in its user's location. This system can operate with multiple applications on a cell phone, and achieves Internet connectivity through a 3G IP based network. This invention solves the seamless mobility problem where network connectivity is lost due to changes in network settings produced by changes in a user's location.

### CROSS REFERENCE

This application claims priority from a U.S. provisional patent application entitled “Non-breakable network connection of cell phone sharing mechanism” filed on Jul. 27, 2007 and having a patent application No. 60/952,536. Such application is incorporated herein by reference.

### FIELD OF THE INVENTION

This invention is relates to a type of seamless mobile network connection system that is used to connect mobile phones to the Internet, and, in particular, it allows peer-to-peer connectivity even as a user's IP changes due to a change in the user's location.

### BACKGROUND

### Current Seamless Mobile Network Connectivity Solutions:

At present there are numerous solutions for providing seamless mobile network connectivity. Although these methods differ, the ultimate goal achieved by each is the same, namely ensuring seamless mobility in the use of network communication software. Following these solutions, we can categorize the network layers of the open system interconnection model into three types: the application layer, the data link layer, and the network layer.

1. Application Layer Solution: Seamless mobility achieved on the application layer essentially refers to transferring the task of managing changes to the IP layer to the application layer's communication protocol. One example of this is strengthening the file transfer protocol (FTP) in order to achieve seamless mobility when downloading documents, music, or video. Because of this, mobility must be added to each simple management protocol, Internet information access protocol, session initiation protocol, and every application layer communication protocol that requires mobility. This type of solution does not require changing mobile device hardware, nor does it require updating network communication equipment. Current standard mobile devices need only be installed with seamless mobility network communication software in order to engage in seamless network connectivity; consideration of current network support level is unnecessary. This invention is an application layer solution.

2. Data Link Layer Solution: Data link layer drivers can be used to achieve IP mobility. Another way to consider data link layer seamless mobility is to use access technology to address all issues of network mobility. IP/Network layers need not be aware of changes in connection points. Currently, GPRS and UMTS networks provide IP mobility solutions that use access technology. When a mobile device is in the GPRS/UMTS network coverage area, this type of model can be used. IEEE 802.11 wireless local area networks also provide data link layer seamless mobility. When a device moves among 802.11 access points in the same distribution system, connectivity can be continually maintained. However, data link layer seamless mobility solutions across different access media are extremely complicated, so other, simpler solutions are often considered as substitutes.

Network Layer Solution: Mobile IP is a solution that addresses seamless mobility issues through the network layer and which originated with the work of the Internet Engineering Task Force (IETF). The network layer hides IP address and network connection changes from the application layer; each piece of application software is unaware of changes in the network environment. Rather than processing each program individually, this type of solution provides seamless mobility to all application software. Although Mobile IP is currently the most researched and employed model, its greatest problem is in deployment and management at the client end. This and the fact that Mobile IP still has deficiencies in the areas of packet handover and route planning have greatly affected network connection quality.

### SUMMARY OF THE INVENTION

The goal of this invention is to provide an application layer seamless mobility solution for cell phones that allows for peer-to-peer network connectivity in order to address the insufficiencies of current seamless mobility solutions for cell phone users, including: (1) excessive complexity of data link layer seamless mobility solutions across different access media; (2) network layer solutions: insufficiently widespread and complete client deployment and management with Mobile IP; and (3) Mobile IP's remaining deficiencies in the areas of packet handover and route planning that result in low-quality network connection.

This solution uses a seamlessly mobile communication method that employs a firewall network tunnel, location transparency, and network status detection and adjustment. When a user moves between networks in different segments, it is able to maintain an uninterrupted connection, thus achieving seamless mobility. Users can connect to the Internet to share photographs and music with family and friends.

In order to reach the goal described above, this invention creates a type of network handshaking method that can determine the network status of two parties that are to be connected and choose the most appropriate method of connection between them. It can also notify each party that the other's network status (e.g. IP, firewall, etc.) changes, or determine if each party's network status changes, thereby causing the network handshaking method to verify the network connection status of both parties in order to choose the most appropriate connection method. This invention also takes advantage of web servers, ping servers, and relay servers to provide the required network information and relay services. When a user completes an operation of the photographing or audio recording functions, the files can be shared with friends by accessing the 3G-linked Internet. Alternatively, users can use their cell phones to access photos or music uploaded by others from cell phones or computers.

Additionally, this invention also provides users with the same software to be installed on their personal computers, thus allowing them to freely choose their connection partners: e.g. computer to computer, computer to cell phone, or cell phone to cell phone. This provides users on different platforms the ability to communicate with each other.

### DESCRIPTION OF THE FIGURES

FIG. 1 is a box diagram of the network structure of servers and users in the methods of this invention.

FIG. 2 is a depiction of the steps for establishing communication in the methods of this invention.

FIG. 3 is a flowchart depicting the steps in the execution of the handshaking process of the methods of this invention.

### DETAILED DESCRIPTION OF THE PREFERRED EMBODIMENTS

### Overall Structure

The accompanying figures demonstrate in further detail the specific examples of realization of this invention.

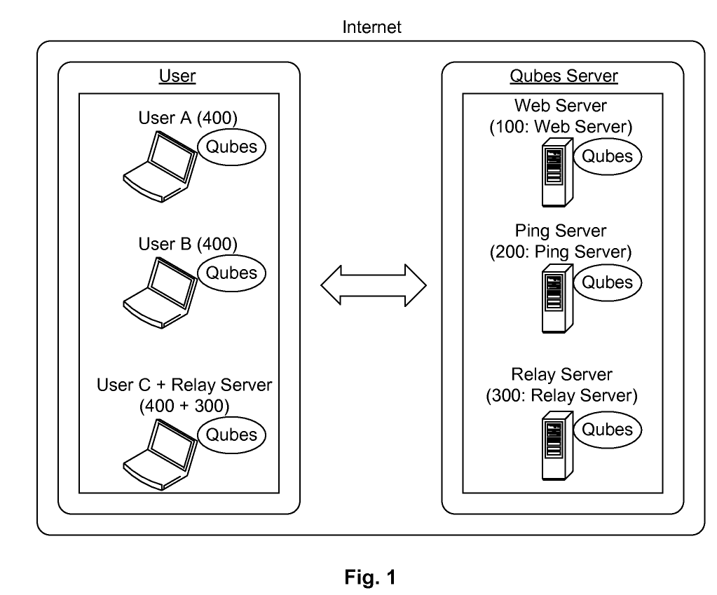

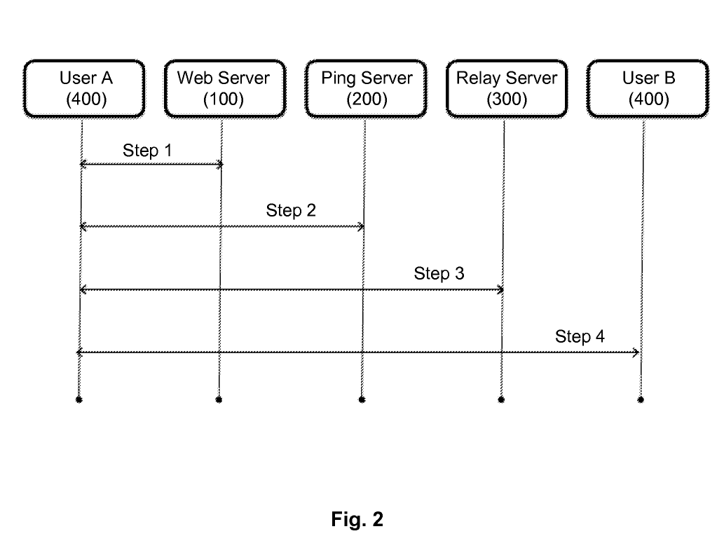

Please see FIGS. 1 and 2. They are an illustration of the network structure of servers and users in the embodiments of this invention, and an illustration of the steps needed to establish communication in the methods of this invention.

These include: a web server (100), a ping server (200), a relay server (300), and users (400).

Web Server (100): Designed using PHP with a MySQL database, installed on a Unix platform. It provides an application programming interface (API) that allows the user-end program to request the required service through XML-RPC (XML is an acronym that stands for eXtensible Markup Language, while RPC is an acronym that stands for Remote Procedure Call). The major services provided by the web server include: request and establishment of the user's account number, user login, verification, and logout functions, as well as storing, editing, and returning user information (e.g. user ID, login time, friend list, whether or not the user is a relay server (100) itself, user's external IP, the IP of the user's relay server (100) to which the user belongs, etc.)

Ping Server (200): Designed using [C++]. It provides ping service to the user's Qubes program. The user's (400) program sends out a notification packet (ping) to the ping server (200), and the ping server (200) returns the user's external IP and port.

Relay Server (300): Designed with C++, same as the user's (400) application program. Any host computer or personal computer, if designated as a relay server, need only run the application program, in which case it will register itself as a relay server (300) with the web server (100) after login, and also notify the web server (100) of its external IP and port to be provided to other users to initiate connection and to provide relay server functionality. There are two main methods by which computers can be designated as a relay server (300): (1) directly define the appropriate account numbers as relay servers with the web server (100) or the user (400); (2) through the user's (400) application, determine whether or not the user's computer or cell phone hardware and network environment are suitable for serving as a relay server (300). The major functions served by the relay server in this invention are: (1) to assist in the transmission of command packets between different users to determine if two parties can connect directly or if it is necessary to go through a relay server (300) to establish a P2P connection; for the detailed method of realization please refer to step 4 of FIG. 2—steps for establishing a connection—as described in the below section; (2) to serve as a data transmission relay point between two users when a P2P connection cannot be directly established between them.

User (400): The user's application program can be separated into an operational interface and a bottom system layer. The operational interface is designed using DHTML and JavaScript, and allows users to access pictures and sound and to manage their friend lists and program settings. The bottom system layer is designed using C++, and mainly provides P2P network connectivity and the advanced service required by the front-end operational interface. The P2P network connectivity function is the focus of this invention; for a detailed method of realization, please refer to FIG. 2 below—steps for establishing a connection.

### Steps for Establishing a Connection

The program initiates a network connection immediately after the cell phone is turned on. The steps for establishing this connection are as follows:

Step 1: When the application program described here is performed, the user (400) uses XMLRPC to login through HTTP to the web server (100) for user verification. After successful verification, the web server (100) stores the user's external IP, and returns to the user (400) information on the user and its friends, including: the IP of the relay server (300) to which the user belongs, friend list, and friends' online statuses.

Step 2: After logging into the web server (100), it is indicated that the user has connected to the Internet and can use HTTP to connect to the web server (100). At this time the user's network status is unknown NAT (Network Address Translation) type. The user sends a ping packet to the ping server (200), and the ping server (200) returns the user's external IP and port. If after a specified amount of time the user still has not received the packet returned by the ping server (200), then the user's network status is viewed as unable to go through UDP (User Datagram Protocol). The user must then go through TCP (Transmission Control Protocol) and establish connection with other users through the relay server (300).

Step 3: After the user receives the packet returned by the ping server (200), the user learns its own external IP and port, establishes connection with the relay server (300), and transmits a packet containing its own external IP and the IP of the relay server (300) to which it belongs to the relay server (300). At this time the relay server (300) stores the user's external IP to allow it to provide relay service at a later time.

Step 4: After the user and the relay server (300) have established a connection, network handshaking with other users is initiated. Because the current detection methods for processing different types of firewalls are overly complicated and are unable to effectively distinguish between firewall types, the network handshaking of this invention does not distinguish between firewall types, but rather splits all types of connections into four simple groups: (1) unable to establish a connection with the other party through the relay server (300); (2) able to establish a connection with the other party through the relay server (300); (3) able to use the other party's external IP to directly connect to the other party; (4) able to use the other party's internal IP to directly connect to the other party. This network handshaking method is used to determine which type of connection the two parties should use to communicate. The detailed application of the handshaking method is as follows:

### Handshaking Prerequisites:

Current user A is able to establish a connection with the relay server (300).
The connection types of current users A and B are preset as unable to establish a connection with the other party through the relay server (300).
The connections as indicated in the operating steps of the network handshaking method are all UDP connections.
Command packets sent out for determination of connection type include the following information: command packet type (designating it as a command packet sent out for determination of connection type), name of the user sending the packet, name of the target receiver of the packet, IP of the user sending the packet, port of the user sending the packet, type of connection type-determining packet. In addition, if the packet is one that is used to determine if an internal IP can be used to establish a connection, the packet must also include the internal IP and port of the user sending the packet.

Connection type-determining packets can be categorized into the following seven types:

1. R: Used to determine whether or not a connection can be established through the relay server.

2. OK R: Used to notify the other party that an R command packet has been received, and to inform the other party that it can establish a connection with the sending party through the relay server (300).

3. OK R2: Used to notify the other party that an OK R command packet has been received, and to inform the other party that it can also establish a connection with the other party through the relay server (300).

4. 4: Used to determine whether or not the other party's external IP can be used to directly establish a UDP connection. Because some STUN's (Simple Transversal of UDP's over NAT's, a network protocol for the simple transversal of different NAT's UDP connections) use the number 4 as the NAT code for the Full Cone NAT type that can use the other party's external IP to directly establish a connection, in this invention the number 4 is used to identify this type of packet.

5. OK 4: Used to notify the other party that a 4 command packet has been received, and to inform the other party that it can establish a connection with the sending party according to its external IP.

6. H: Used to determine whether or not the other party's internal IP can be used to directly establish a UDP connection. Because the internal IP can be used to establish a connection in a network environment that does not support Hairpin functionality (Hairpin: when different machines are located in the same router field and the two machines use each other's external IP's and ports to transfer packets, the router can use the IP reference material table deployed by the NAT to change the external IP's and ports into internal IP's and ports, and then send the packets to other machines located on the same router), this invention uses the letter H to designate this type of packet.

7. OK H: Used to notify the second party that an H command packet has been received, and to inform the second party that it can establish a connection with the sending party according to its internal IP.

Although the complete handshaking method has a total of eight steps, it can only be completely executed when users can directly establish a connection between themselves. In real cases there is the possibility that the two sides will be unable to directly establish a connection using either the external or internal IP. In these cases, the other party will be unable to receive the command packet sent by the sending party. When this happens, the remaining steps will no longer be taken and the best connection type initially recorded by the users will be used as the connection type for the two parties; the parties can then use this connection type to establish a connection and share photos and music.

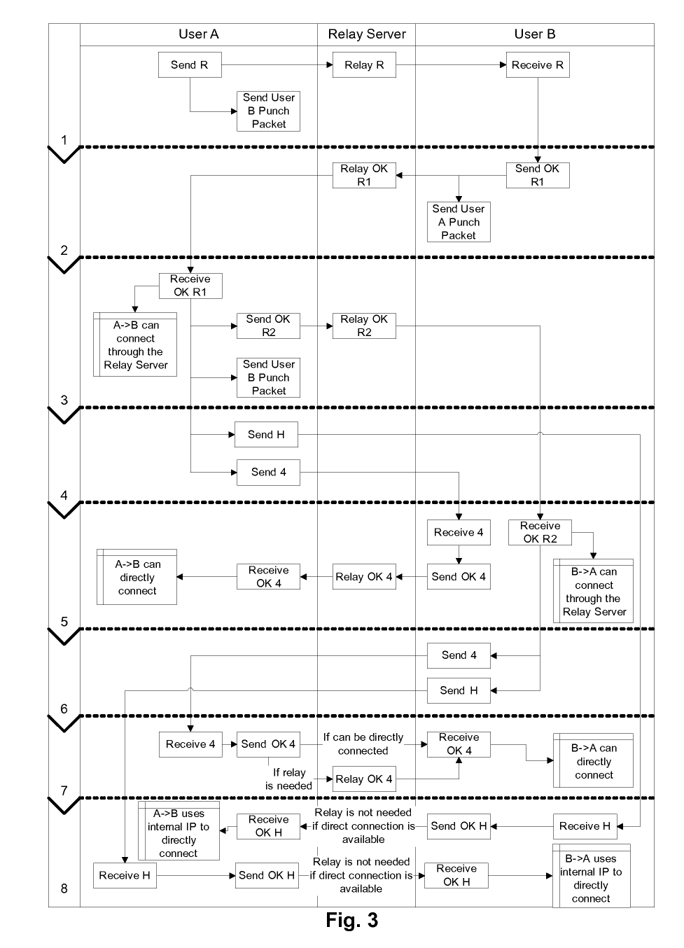

### Steps in the Execution of the Handshaking Method (See FIG. 3):

1. User A transmits command packet R to User B through the relay server (300), while at the same time User A directly transmits a punch packet to User B in order to open a firewall path for User B to use.

2. After receiving command packet R, User B sends a confirming command packet OK R to User A through the relay server (300) in order to confirm receipt. At the same time, User B directly transmits a punch packet to User A in order to open a firewall path for User A to use.

3. After receiving confirming command packet OK R, User A records in its program that it can use the relay server (300) to establish a one-way connection with User B. At this time, user A will send a command packet OK R2 to User B through the relay server (300) in order to confirm receipt of User B's packet. User A will also directly transmit a punch packet to User B in order to ensure the establishment of a path through the firewall.

4. User A directly transmits command packet 4 to User B according to User B's external IP and port, without going through the relay server (300). Additionally, in order to resolve the problem of some users' network environment lack of support for Hairpin, User A also directly transmits command packet H to User B according to User B's internal IP and port.

5. After receiving confirming command packet OK R2 sent by User A in Step 3, User B records in its program that it can use the relay server (300) to establish a one-way connection with User A. When User B receives command packet 4 directly sent to it by User A, it sends confirming command packet OK 4 to User A through the relay server (300). After receiving a confirming command packet OK 4 sent by User B, User A records in its program that it does not need to go through the relay server (300), but rather can directly establish a one-way connection with User B.

6. User B directly transmits command packet 4 to User A according to User A's external IP and port, and does not do through the relay server (300). Additionally, in order to resolve the problem of some users' network environments lack of support for Hairpin, User B also directly transmits command packet H to User A according to User A's internal IP and port.

7. When User A receives command packet 4 directly sent to it by User B, it sends a confirming command packet OK 4 to User B. After receiving a confirming command packet OK 4 sent by User A, User B records in its program that it does not need to go through the relay server (300), but rather can directly establish a one-way connection with User A.

8. When users A/B respectively receive the command packets H directly sent to each other using each other's internal IP's and ports, Users A/B both send confirming command packets OK H to each other. When Users A/B receive these confirming command packets, they both record in their programs that Users A/B can use each other's internal IP's and ports to directly establish one-way connections with each other. In this way, the problem of both parties' networks lacking support for Hairpin can be resolved.

### Resolution Method for Changing Network Environments:

In order to achieve seamless mobility, this invention must be able to address all types of changes in network environments by selecting the most appropriate response to maintain continual connection. Multiple types of network environment changes are describes in detail below, along with the respective methods in addressing these changes:

Changes in the Other Party's Network IP: In the handshaking method of this invention, in order to determine the connection type, all command packets contain the sender's name, network IP, and port information. Inter-user keep-alive packets sent out at regular intervals also contain the sender's name, network IP, and port information. The receiver of these packets records the sender's network IP and port information according to the sender's name. As a result, when the receiver receives these packets, if it is discovered that the network IP and port information contained in a packet sent by a sender is different from that originally recorded by the receiver, it means that the IP of the sender has changed. In this case, the receiver's program reinitiates the handshaking process in order to confirm the two parties' connection type, and communicates with the sender in accordance with the new connection type. In this way, when a change in a cell phone user' location leads to a change in his/her network IP address, this invention can detect the changed network environment and immediately adapt in order to maintain connection, thus achieving seamless mobility.

Two Parties are Unable to Form a Connection Due to a Change in Connection Type: When a party is unable to establish a connection with the other party, it is sometimes caused by a change in the connection type between the two parties. The most common reason for a change in connection type is a change in the NAT settings of at least one of the two parties. One example of this might be if two parties could originally directly establish a connection, but because of a change in firewall settings from Full Cone to Symmetric they are unable to establish a connection. When an inability to establish a connection occurs, the handshaking process is reinitiated between the two users. The handshaking method of this invention begins by attempting to establish a connection between the two users using the simplest method possible (going through the relay server (300) to establish a connection) and then in accordance with the determined results decides if more favorable methods of establishing a connection should be attempted (using the other party's external IP to directly establish a connection). As a result, when the firewall settings change from Full Cone to Symmetric, after another execution of the handshaking process, the users will establish a connection with each other through the relay server (300) in accordance with the determined results from the handshaking process.

Abnormal Network Causes an Inability to Establish a Connection: When a connection cannot be established even through the relay server (300), the user's program will test whether or not it is able to establish a connection with the ping server (200) and the relay server (300). If a connection is possible, this means that it is an abnormality in the other party's network that caused the loss of connection, and the user's program will continue running. If the user is unable to establish a connection with the ping server (200) and the relay server (300), this means that the user's own network has an abnormality. In this case, the user's program will send out a request to the web server (100), asking the web server (100) to verify the user's network status and to report back to the user. If the user cannot even connect to the web server (100), then the user is unable to establish a connection with any other user, and the user's program will be automatically logged off.

Other Methods of this Invention

Here are listed a few other possible methods:

(1) Employing the User as The relay server (300): The current system structure of this invention includes a design in which a normal user acts as a relay server (300). As long as the user itself has relatively strong computational power and has a rather large network bandwidth, it can be used as a relay server (300) for other users.

(2) Methods for Network Handshaking: There are numerous realization methods for network handshaking; the above described method is but one of them. The focus of this invention is in replacing the current STUN (Simple Transversal of UDP's over NAT's, a network protocol for the simple transversal of different NAT's UDP connections) that is most often used to determine the NAT type. The realization method for the current STUN is to separate firewalls into a certain number of types, after which the STUN server is used to differentiate between the firewall types, and an appropriate connection type is selected based on the determined results. However, this invention does not require a determination of the firewall type, nor does it require a STUN server. This invention is based on connection types, which it separates into four types: unable to go through the relay server (300) to establish a connection with the other party, able to go through the relay server (300) to establish a connection with the other party, able to use the other party's external IP to directly establish a connection, and able to use the other party's internal IP to directly establish a connection. This simplifies the handshaking for establishing a network connection.

(3) Combining the Web Server (100) and the Ping Server (200) into One Server: Although FIG. 1 depicts these servers as separate, it is possible to use a single server to perform the functions of both of these. FIG. 1 is drawn with them separate in order to more clearly depict each server's functionality.

In summary, an application layer seamless mobility solution for cell phones that can also allow for multimedia network sharing is disclosed. This solution has two important characteristics: (1) it views cell phones as servers and allows sharing of multimedia content from cell phone to cell phone or cell phone to computer; (2) it uses the network system structure depicted in the figures, the steps for establishment of a network connection in this invention, the network handshaking, and the resolution methods for changes in the network environment in an attempt to achieve seamless mobility for cell phone users.

The network system structure includes the following elements: (a) web server (100): it provides user login and verification functionality, as well as storage of relevant user information and an application program interface (API) that allows the user's program to request needed service; (b) ping server (200): it returns the user's external IP and port to the user; (c) relay server (300): it assists in the transmission of network control packets between the different users, and serves as a resource relay point between two users; (d) User (400): it allows the users to access photos and music, and to manage their friend lists and program settings; also provides P2P connectivity functionality.

### Steps for Establishing a Network Connection and Handshaking:

Step 1: The user (400) uses XMLRPC to login through HTTP to the web server (100) for user verification. After successful verification, the web server (100) stores the user's external IP, and returns information on the user and its friends.

Step 2: After logging into the web server (100), the user's network status is an unknown NAT type. A ping packet can be sent to the ping server (200), and the ping server (200) returns the user's external IP and port. If after a specified amount of time the user has still not received the packet returned by the ping server (200), then the user's network status is viewed as unable to go through UDP. The user must then go through TCP and establish connection with other users through the relay server (300).

Step 3: After the user receives the packet returned by the ping server (200), the user learns its own external IP and port, establishes connection with the relay server (300), and transmits a packet containing its own external IP and the IP of its relay server (300) (to which it belongs to). At this time the relay server (300) stores the user's external IP to allow it to provide relay service at a later time.

Step 4: After the user and the relay server (300) have established a connection, the network handshaking process with other users is initiated. The network handshaking process of this invention simplifies and splits all types of connections into four simple groups: (1) unable to establish a connection with the other party through the relay server (300); (2) able to establish a connection with the other party through the relay server (300); (3) able to use the other party's external IP to directly connect to the other party; (4) able to use the other party's internal IP to directly connect to the other party. This network handshaking process is used to determine which type of connection two parties should use to communicate. The detailed method for application of the handshaking process is as follows:

### Steps for Implementing Handshaking (See FIG. 3):

Packets are sent between the users to each other through the relay server (300), then it is determined whether or not it is possible to connect with each other through the relay server (300) based on whether or not confirmation packets are returned. At the same time, the users will directly send each other punch packets to open a firewall path.

If the relay server (300) can be used to establish a connection, then users directly send each other packets, and determine whether or not it is possible to establish a direct connection with each other based on whether or not confirmation packets are returned.

In addition, in order to resolve the problem where some users' network environment lack support for Hairpin, users then directly transmit packets based on the other party's internal IP and port, and determine whether or not it is possible to establish a direct connection with each other using each other's internal IP and port based on whether or not confirmation packets are returned.

### Resolution Method for Changes in Network Environment

(a) Changes in the Other Party's Network IP: When it is discovered that there has been a change in the other party's network IP, the receiver's program reinitiates the handshaking process in order to confirm the two parties' connection type, and communicates with the sender in accordance with the new connection type, thus achieving seamless mobility.

b) Two Parties are Unable to Form a Connection Due to a Change in the Connection Type: When an inability to establish a connection due to a change in the connection type occurs, the handshaking process is reinitiated between the two users. The handshaking process of this invention begins by attempting to establish a connection between the two users using the simplest method possible, and then in accordance with determined results decides if more favorable methods for establishing a connection should be attempted. As a result, users will establish a connection based on the handshaking results.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for establishing and maintaining a seamless mobility connection for mobile users, comprising the steps of:
sending by a first user a ping packet to a ping server;
if the first user's external IP is received from the ping server, establishing by the first user a connection with a relay server, said relay server having an IP; transmitting by the first user a command packet containing the first user's external IP and the IP of said relay server to said relay server; and storing by said relay server the first user's external IP;
transmitting by a first user a first command packet to a second user through said relay server;
sending by the second user in response to said first command packet a first confirming command packet to the first user through said relay server;
recording by the first user, when the first user receives the first confirming command packet, that the relay server can be used to establish a one-way connection with the second user; and
directly transmitting by the first user a second command packet to the second user according to the second user's external IP, without going through the relay server, thereby establishing a connection between the first user and the second user.

2. The method of claim 1, further comprising the steps of:
recording by the second user, when the second user receives a second confirming command packet from the first user, that the relay server can be used to establish a one-way connection with the first user; and
directly transmitting by the second user a third command packet to the first user according to the first user's external IP, without going through the relay server, thereby establishing a connection between the first user and the second user.

3. The method of claim 1 wherein the first user directly transmits a punch packet to the second user in order to ensure the establishment of a path through a firewall.

4. The method of claim 1 wherein the second user directly transmits a punch packet to the first user in order to ensure the establishment of a path through a firewall.

5. The method of claim 1 wherein if the second user's network environment does not support Hairpin, the first user directly transmitting a command packet H to the second user according to the second user's internal IP and port.

6. The method of claim 1 wherein if the first user's network environment does not support Hairpin, the second user directly transmitting a command packet H to the first user according to the first user's internal IP and port.

7. The method of claim 5 wherein if the first user's network environment does not support Hairpin, the second user directly transmitting a command packet H to the first user according to the first user's internal IP and port.

8. The method of claim 1 wherein upon discovering that one of the user's IP information has changed, repeating the steps of claim 1 and claim 2 (the handshaking process) in order to determine the connection type for the first user and the second user.

9. The method of claim 5 wherein the first user and the second user establish a connection with each other through the relay server upon discovering that one of the user's IP information has changed.

10. The method of claim 1 wherein the user can be a mobile phone user.

11. The method of claim 1 wherein the user can be a computer user.

12. The method of claim 10 wherein the user can be a computer user.

13. A method for establishing and maintaining a seamless mobility connection for mobile users, comprising the steps of:
sending by a first user a ping packet to a ping server;
if the first user's external IP is received from the ping server, establishing by the first user a connection with a relay server, said relay server having an IP; transmitting by the first user a command packet containing the first user's external IP and the IP of said relay server to said relay server; and storing by said relay server the first user's external IP;
transmitting by a first user a first command packet to a second user through said relay server;
sending by the second user in response to said first command packet a first confirming command packet to the first user through said relay server;
recording by the first user, when the first user receives the first confirming command packet, that the relay server can be used to establish a one-way connection with the second user;
directly transmitting by the first user a second command packet to the second user according to the second user's external IP, without going through the relay server, thereby establishing a connection between the first user and the second user;
recording by the second user, when the second user receives a second confirming command packet from the first user, that the relay server can be used to establish a one-way connection with the first user; and
directly transmitting by the second user a third command packet to the first user according to the first user's external IP, without going through the relay server, thereby establishing a connection between the first user and the second user.

14. The method of claim 13 wherein the first user directly transmits a punch packet to the second user in order to ensure the establishment of a path through a firewall, and wherein the second user directly transmits a punch packet to the first user in order to ensure the establishment of a path through a firewall.

15. The method of claim 13 wherein if the second user's network environment does not support Hairpin, the first user directly transmitting a command packet H to the second user according to the second user's internal IP and port, and wherein if the first user's network environment does not support Hairpin, the second user directly transmitting a command packet H to the first user according to the first user's internal IP and port.

16. The method of claim 13 wherein upon discovering that one of the user's IP information has changed, repeating the steps of claim 1 and claim 2 (the handshaking process) in order to determine the connection type for the first user and the second user.

17. The method of claim 16 wherein the first user and the second user establish a connection with each other through the relay server upon discovering that one of the user's IP information has changed.

18. The method of claim 13 wherein the user can be a mobile phone user, and wherein the user can be a computer user.

19. A method for establishing and maintaining a seamless mobility connection for mobile users, comprising the steps of:
sending by a first user a ping packet to a ping server;
if the first user's external IP is received from the ping server, establishing by the first user a connection with a relay server, said relay server having an IP; transmitting by the first user a command packet containing the first user's external IP and the IP of said relay server to said relay server; and storing by said relay server the first user's external IP;
transmitting by a first user a first command packet to a second user through said relay server;
sending by the second user in response to said first command packet a first confirming command packet to the first user through said relay server;
recording by the first user, when the first user receives the first confirming command packet, that the relay server can be used to establish a one-way connection with the second user;
directly transmitting by the first user a second command packet to the second user according to the second user's external IP, without going through the relay server, thereby establishing a connection between the first user and the second user;
recording by the second user, when the second user receives a second confirming command packet from the first user, that the relay server can be used to establish a one-way connection with the first user; and
directly transmitting by the second user a third command packet to the first user according to the first user's external IP, without going through the relay server, thereby establishing a connection between the first user and the second user;
wherein the first user directly transmits a punch packet to the second user in order to ensure the establishment of a path through a firewall; wherein the second user directly transmits a punch packet to the first user in order to ensure the establishment of a path through a firewall; wherein if the second user's network environment does not support Hairpin, the first user directly transmitting a command packet H to the second user according to the second user's internal IP and port; wherein if the first user's network environment does not support Hairpin, the second user directly transmitting a command packet H to the first user according to the first user's internal IP and port; wherein upon discovering that one of the user's IP information has changed, repeating the steps of claim 1 and claim 2 (the handshaking process) in order to determine the connection type for the first user and the second user; wherein the first user and the second user establish a connection with each other through the relay server upon discovering that one of the user's IP information has changed.

20. The method of claim 13 wherein the user can be a mobile phone user, and wherein the user can be a computer user.
